(19) United States
(12) Patent Application Publication
(10) Pub. No.: US 2022/0300912 A1
(43) Pub. Date: Sep. 22, 2022

(54) RESERVING CONFERENCE IN ELECTRONIC CALENDAR PURSUANT TO ELECTRONIC CALENDAR RESTRICTION(S)

(71) Applicant: Lenovo (Singapore) Pte. Ltd., Singapore (SG)

(72) Inventors: Russell Speight VanBlon, Raleigh, NC (US); Jonathan Co Lee, Cary, NC (US); Philip Lee Childs, Fort Wayne, IN (US); Ratan Ray, Cary, NC (US)

(21) Appl. No.: 17/838,206

(22) Filed: Jun. 11, 2022

Related U.S. Application Data
(62) Division of application No. 15/930,328, filed on May 12, 2020.

(51) Int. Cl. G06Q 10/10

(52) U.S. Cl. CPC G06Q 10/1095; G06Q 10/107

(57) ABSTRACT

In one aspect, a device may include at least one processor and storage accessible to the at least one processor. The storage may include instructions executable by the at least one processor to receive a request to book a meeting with a user via an electronic calendar. The electronic calendar may be associated with the user. The instructions may also be executable to, responsive to receipt of the request, determine a restriction associated with the electronic calendar and to respond to the request pursuant to the restriction.

### FIELD

The present application relates to technically inventive, non-routine solutions that are necessarily rooted in computer technology and that produce concrete technical improvements.

### BACKGROUND

As recognized herein, in terms of electronic calendars in particular, sharing calendars amongst users can be problematic as it often exposes personal electronic data indicated in the calendar to others and therefore raises digital privacy concerns. As also recognized herein, current electronic calendar systems result in unnecessary electronic interactions and emails being sent between various users in order to coordinate a meeting. This compounds the process and leads to confusion among the users, particularly where the users might not be technology-savvy. There are currently no adequate solutions to the foregoing computer-related, technological problem.

### SUMMARY

Accordingly, in one aspect a device includes at least one processor and storage accessible to the at least one processor. The storage includes instructions executable by the at least one processor to receive a request to book a meeting with a user via an electronic calendar, where the electronic calendar is associated with the user. The instructions are also executable to, responsive to receipt of the request, determine a restriction associated with the electronic calendar and respond to the request pursuant to the restriction.

In some example implementations, the restriction may permit a single request to book a meeting via the electronic calendar during a recurring period of time and may otherwise reject requests to book meetings during the same recurring period of time. Additionally or alternatively, the restriction may permit requests to book meetings up to a threshold future date and/or future time but not beyond the threshold future date and/or future time.

As another example implementation, the restriction may permit a response to the request indicating only one available timeslot despite multiple timeslots being available in the electronic calendar. So, for example, a response to the request indicating only one available timeslot may be provided responsive to a threshold number of timeslots being available via the electronic calendar, where the threshold number may be greater than one. Further, if desired a response to the request may not be provided responsive to less than the threshold number of timeslots being available via the electronic calendar.

Still further, in some example implementations the restriction may permit responses to requests to book meetings via the electronic calendar responsive to the requests being made by predetermined people. In addition to or in lieu of the foregoing, the restriction may permit responses to requests to book meetings via the electronic calendar responsive to the requests being made using predetermined email addresses, and/or responsive to the requests being made by people associated with particular predetermined website domains and/or email domains.

Also in some example implementations, the restriction may permit responses to requests to book meetings via the electronic calendar responsive to the requests being made by people indicated in a contact list associated with the user. Furthermore, in some examples the restriction may permit responses to requests to book meetings via the electronic calendar responsive to the requests being made by a subset of people in the contact list that does not include all people indicated in the contact list, such that people outside the subset may not be permitted to book meetings via the electronic calendar according to the restriction.

In yet another example implementation, the restriction may permit responses to requests to book meetings via the electronic calendar responsive to the requests being provided by people with whom the user has electronically communicated within a threshold time of a time at which the request is received.

Still further, in some examples the instructions may be executable to, responsive to the device responding to a threshold number of requests to book meetings, disable additional responses to requests to book meetings via the electronic calendar until the user again authorizes responses to requests to book meetings.

In another aspect, a method includes receiving a request to reserve a conference time via an electronic calendar. Responsive to receiving the request, the method includes determining a restriction associated with the electronic calendar and electronically responding to the request pursuant to the restriction.

In certain example implementations, the restriction may permit a single request to reserve a conference time via the electronic calendar during a recurring period of time and may otherwise reject requests to reserve conference times during the same recurring period of time.

If desired, in some instances the method may include, responsive to responding to a threshold number of requests to reserve conference times during a threshold period of time, disabling additional responses to requests to reserve conference times via the electronic calendar until a user associated with the electronic calendar again authorizes responses to requests to reserve conference times.

Also in certain examples, the method may be executed by a first device and the electronic calendar may be accessible from a second device associated with transmission of the request to the first device. The electronic calendar may thus be accessible from the second device to indicate available timeslots without indicating other time reservations in the electronic calendar.

Additionally, in some examples the method may include, responsive to receiving the request, generating and transmitting an email to an email account associated with a user, where the user is associated with the electronic calendar. The email may indicate that the request has been received.

In still another aspect, at least one computer readable storage medium (CRSM) that is not a transitory signal includes instructions executable by at least one processor to generate an electronic request to reserve, via an electronic calendar, a conference time for a conference of a particular length of time. The electronic request does not request a particular date and time of day for the conference. The instructions are also executable to transmit the electronic request to a device that manages the electronic calendar, receive a response to the electronic request from the device, and present an output indicating the response on a display accessible to the at least one processor.

In certain examples, the electronic request to reserve the conference time may pertain to one or more of an in-person conference and a telephonic conference. Further, in some examples the instructions may be executable to present, on the display, a graphical user interface (GUI) at which user input is receivable to specify the particular length of time and at which user input is receivable to specify a time frame within which the conference is requested to transpire.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example graphical user interface (GUI) that may be used by a first user for requesting a meeting or conference with a second user consistent with present principles;

FIG. 4 shows a GUI that may be presented to the first user responsive to a meeting request being denied consistent with present principles;

FIG. 5 shows a GUI that may be presented to the first user responsive to a meeting request being approved consistent with present principles;

FIG. 6 shows a GUI that may be presented to the second user for a meeting request that has been approved consistent with present principles;

FIG. 7 shows a GUI that may be presented to the second user for a meeting request that has been denied consistent with present principles;

FIG. 8 shows a GUI at which calendar restrictions may be set consistent with present principles;

FIG. 9 shows a flow chart of an example algorithm that may be executed by a device requesting a meeting or conference consistent with present principles; and

FIG. 10 shows a flow chart of an example algorithm that may be executed by a device hosting an electronic calendar for which a meeting request has been received consistent with present principles.

### DETAILED DESCRIPTION

Among other things, the present application provides “one party” access to a user's calendar so that one person could setup an event without interfering with or overlapping other events on the same calendar.

For example, users A and B may share “restricted pull” permission to each other's calendars. This may allow either user to “pull” the other calendar, but with some user-customizable caveats. One might be that the calendar can only be pulled once per X time period (e.g., only allow 1 pull per month). Another might be that the calendar can only be seen up to X days in advance (e.g., only provide this week's free time). The calendar owner may even be notified each time his or her calendar is pulled to provide assurance against abuse.

Additionally or alternatively, in some non-limiting examples the calendar may only provide simple timeslot responses. E.g., user A may request multiple 1-hour timeslots, and user B's calendar may auto-respond with only 1 timeslot accepted without indicating if other possible timeslots were available or not. In some examples user A could even specify the minimum number of 1-hour timeslots required for a response.

Furthermore, for busy users, a 1-hour timeslot could be requested within a certain time period (e.g., “Give me 1 hour you're available next week”). This request could be for general availability, or for availability for a phone call, in person meeting, or on or off-site meetings specifically (e.g., where this knowledge might be available on the user's calendar, or if the user had pre-configured office hours).

Present principles may apply where meeting requests are bounced off multiple different calendars for the same user for which a meeting is sought (e.g., work, family, and volunteer calendars). Present principles also apply in instances where more than two users are seeking to coordinate a meeting amongst calendars for the more-than-two users.

Implementation and maintaining the calendar itself could occur on a client device or in a cloud environment, for example.

Calendars may be shared, and appointments booked, using other criteria as well. For example, the user may set the calendar to permit people to book appointments where those people are associated with specific email addresses/usernames, specific domains (e.g., a company's email domain), an entire contact list of the user, or even specific groups within a contact list (e.g., friends, family, colleagues could all have different base permissions/restrictions for booking appointments for the same electronic calendar).

Furthermore, as another example another restriction might be that only those people can automatically book appointments on the user's calendar that have communicated with the user recently, or on a recurring basis. For example, pulls could be allowed for people the user communicated with via phone/text/email over the past 30 days, or those the user communicated with at least once per quarter for the past X time period.

In some examples, a 1-time share feature may also be used where, rather than the user having to disable abusers, the user may have to re-enable calendar pulls each time the calendar is pulled (or after X number of pulls) by a particular person or by all people.

For multi-user organizations (such as multiple developers working with multiple people from third-party companies), present principles may be applied for multiple pulled users. For example, a system operating consistent with present principles could find a common, available 1-hour slot among 5 invitees and show the available free time for all of them while not showing any other details for the individuals from their respective calendars.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

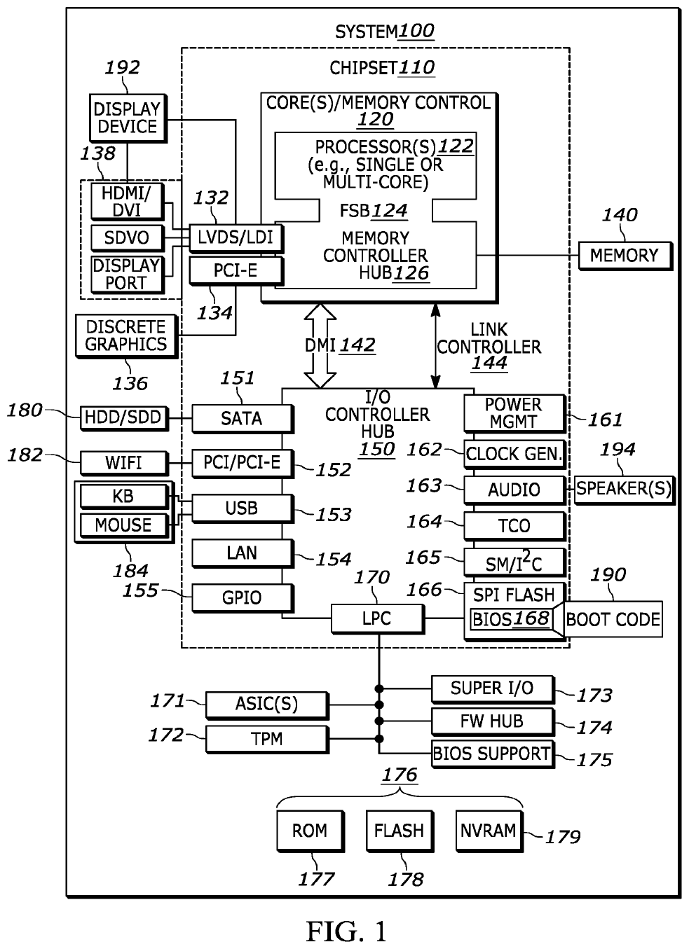

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Still further, the system 100 may include an audio receiver/microphone that provides input from the microphone to the processor 122 based on audio that is detected, such as via a user providing audible input to the microphone. The system 100 may also include a camera that gathers one or more images and provides images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

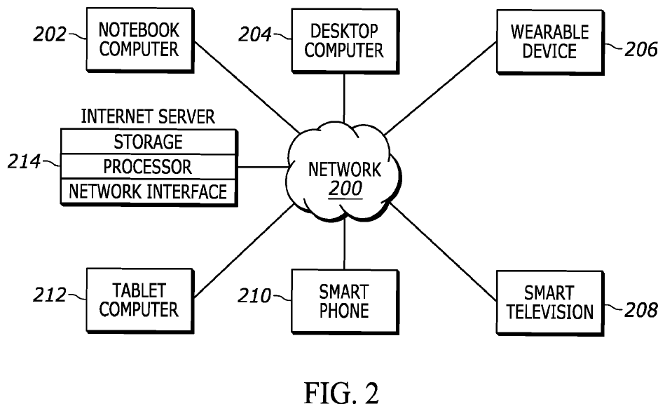

Turning now to FIG. 2, example devices are shown communicating over a network 200 such as the Internet in accordance with present principles for booking meetings, appointments, conferences, etc. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles. So, for example, the respective electronic calendars of various users may be maintained in cloud storage hosted at the server 214 so that meetings and conferences may be booked via the server 214 as described herein. However, also note that in some examples one or more of the calendars may be hosted/stored at one of the other devices 202-212.

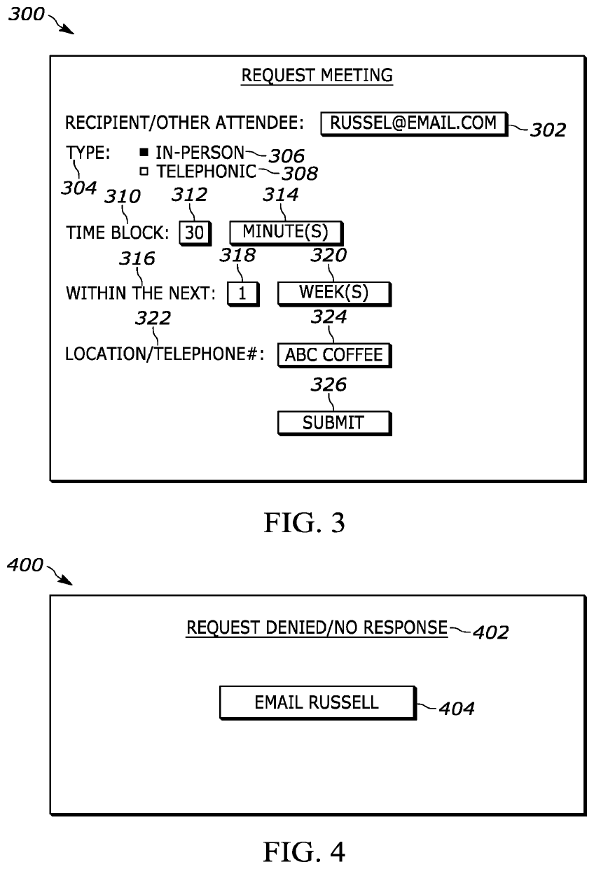

Referring now to FIG. 3, it shows an example graphical user interface (GUI) 300 that may be presented on the display of a first device associated with a first user that wishes to request a meeting or conference with a second user different from the first user. In this example, the first user is named Jonnie and the second user is named Russell. The GUI 300 may be presented as part of a web portal/website or calendar application executing at the first device, for example.

As shown, the GUI 300 may include a first input box 302 into which the first user may enter or specify the second user using a hard or soft keyboard. The second user may be specified by system username, actual name, or email address, for example. In this case, the first user has specified the second user by email address as shown. Also note that more than one other meeting participant may be specified via input to input box 302 if the meeting is for, e.g., three or more people.

The GUI 300 may also include a section 304 at which the first user specify whether the meeting the user is seeking to book is to be an in-person meeting (option 306) or telephonic meeting/conference (option 308). In this example, option 306 has been selected by the first user by directing touch or cursor input to the respective check box for that option.

As also shown in FIG. 3, the GUI 300 may include a section 310 at which the first user may specify a block, length, or amount of time being requested for the meeting. The first user may specify the requested amount of time by directing numerical input to input box 312 and then selecting selector 314, which in turn may cause a drop-down menu to be presented from which various units of time may be selected such as minutes or hours. The selected unit of time may then be reflected on the face of the selector 314 itself as shown. In this case, the first user has selected thirty minutes as the block of time being requested.

Further, the GUI 300 may include a section 316 at which the first user may specify a future time period during which the first user would like the meeting to transpire, where the future time period may be relative to the current time at which the request itself is created/submitted. The first user may specify the time period by directing numerical input to input box 318 and then selecting selector 320, which in turn may cause a drop-down menu to be presented from which various units of time may be selected such as days, weeks, or months. The selected unit of time may then be reflected on the face of the selector 320 itself as shown. In this case, the first user has specified the time period as being within one week of when the request is made.

Still further, the GUI 300 may include a section 322 at which the first user may specify a location at which he or she wishes the meeting to transpire (e.g., if option 306 were selected for an in-person meeting) or at which the first user may specify a telephone number for one or both users to call to initiate/participate in the meeting (e.g., if option 308 were selected for a telephonic meeting). The location or telephone number may therefore be specified by directing user input to input box 324 using a hard or soft keyboard, for example. In this case, since the first user is requesting an in-person meeting, the first user has entered the location of a coffee shot named “ABC coffee” into the box 324.

After the desired meeting details have been provided by the first user using the GUI 300, the first user may then select the submit selector 326 in order to command the first user's device to generate and electronically transmit the request according to the desired meeting details. The request may be transmitted to whatever electronic device is hosting the second user's calendar, such as a remotely-located server hosting the second user's calendar or even the second user's smartphone if the second user's calendar is hosted at the smart phone.

Turning to FIG. 4, a GUI 400 is shown that may be presented on the display of the first user's device responsive to the first user's meeting request being denied by the second user's electronic calendar (or associated hosting device) pursuant to one or more restrictions for the second user's calendar. The GUI 400 may be presented as part of an email the first user receives as a response to the request, or may be presented as part of the online portal or calendar application used to initially submit the request as referenced above.

As shown in FIG. 4, the GUI 400 may include a prompt 402 indicating that the first user's request to book a meeting with the second user has been denied and/or indicating that no response has been received from the second user's electronic calendar within a predetermined timeout period. The GUI 400 may also include a selector 404 that may be selected by the first user using touch or cursor input. The selector 404 may be selected to command the first user's device to generate and present an email draft on the display of the first user's device that already has the second user's email address pre-filled in the recipient field of the email draft and a predetermined subject like “Re: Denied Meeting Request” pre-filled in the subject field of the email draft. The first user may then type additional information into the body section of the email daft and then send the email to the second user to follow-up on the denied request with a written email request to the second user.

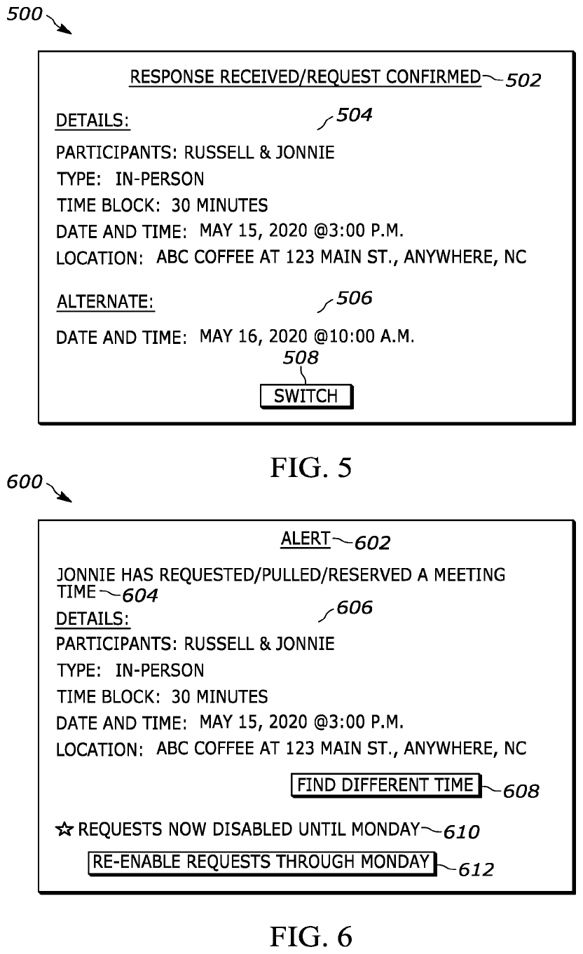

Now in reference to FIG. 5, a GUI 500 is shown that may be presented on the display of the first user's device responsive to the first user's meeting request being approved pursuant to one or more of the second user's calendar restrictions. The GUI 500 may be presented as part of an email the first user receives as a response to the request, or may be presented as part of the online portal or calendar application used to initially submit the request as referenced above. And note that the meeting itself may have been confirmed by the second user's electronic calendar without the second user himself or herself providing input specifically in response to the request in order to approve it.

As shown in FIG. 5, the GUI 500 may include a prompt 502 indicating that the first user's request to book a meeting with the second user has been confirmed and/or approved. The GUI 500 may also include a section 504 listing various details of the now-confirmed meeting, such as the participants (Russell and Jonnie in this example), the type of meeting (in-person in this example), the time block allotted for the meeting (30 minutes in this example), the date and time of day for the meeting (May 15, 2020 at 3:00 p.m. local time in this example), and the location at which the confirmed meeting is to take place (ABC Coffee at 123 Main Street, Anywhere, N.C. in this example).

In some examples, the GUI 500 may also include a section 506, e.g., depending on the settings for the second user's electronic calendar as configured by the second user. The section 506 may list an alternate meeting date and time that the first user may select if the first user prefers the alternate meeting date and time over the one that has already been confirmed by the second user's electronic calendar (or associated hosting device). As shown in this example, the alternate meeting date and time being proposed is May 16, 2020 at 10:00 a.m. local time. The section 506 may also include a selector 508 that may be selectable to transmit an electronic message to the second user's electronic calendar to switch the meeting between the two users to the alternate time rather than the already-confirmed time, which in turn may cause the already-confirmed time as blocked off in the second user's calendar to become unblocked and the alternate time to be blocked off instead in the second user's calendar.

Now referring to FIG. 6 and continuing from the example above, this figure shows an example GUI 600 that may be presented on the display of the second user's device responsive to the second user's electronic calendar autonomously booking the requested meeting with the first user. The GUI 600 may be presented as part of an email the second user receives after the request has been confirmed pursuant to one or more restrictions for the second user's calendar, or may be presented as part of an online portal/website or calendar application for the second user's calendar.

As shown in FIG. 6, the GUI 600 may include a prompt or alert 602 along with text 604 indicating that the first user, Jonnie, has requested or “pulled” a meeting with the second user, Russell, that has been confirmed and reserved by the second user's calendar. The GUI 600 may also include a section 606 listing various details of the confirmed meeting, such as the participants (Russell and Jonnie in this example), the type of meeting (in-person in this example), the time block allotted for the meeting (30 minutes in this example), the date and time of day for the meeting (May 15, 2020 at 3:00 p.m. local time in this example), and the location at which the confirmed meeting is to take place (ABC Coffee at 123 Main Street, Anywhere, N.C. in this example)

If desired, the section 606 may also include a selector that may be selectable by the second user to command the second user's electronic calendar to autonomously locate and confirm a different meeting date and time for the meeting and to vacate the currently-scheduled meeting on May 15, 2020 in the second user's calendar. Responsive to the different meeting date and time being confirmed, the second user's electronic calendar or associated hosting device may then provide another notification to the first user, such as a notification similar to that described above in reference to FIG. 5 but with the new details replacing the old ones.

As also shown in FIG. 6, the GUI 600 may include an indication 610 that additional meeting/conference requests to the second user's electronic calendar have been disabled until a predetermined future time, e.g., based on restrictions the second user has put in place for his electronic calendar. This may be useful so that the second user's calendar does not book up substantially or completely, and thus allows the second user a away of managing the calendar while still allowing some appointments to be booked. A selector 612 may also be presented on the GUI 600, where the selector 612 may be selectable to command the second user's electronic calendar to again permit at least a threshold additional number of bookings through the predetermined future time.

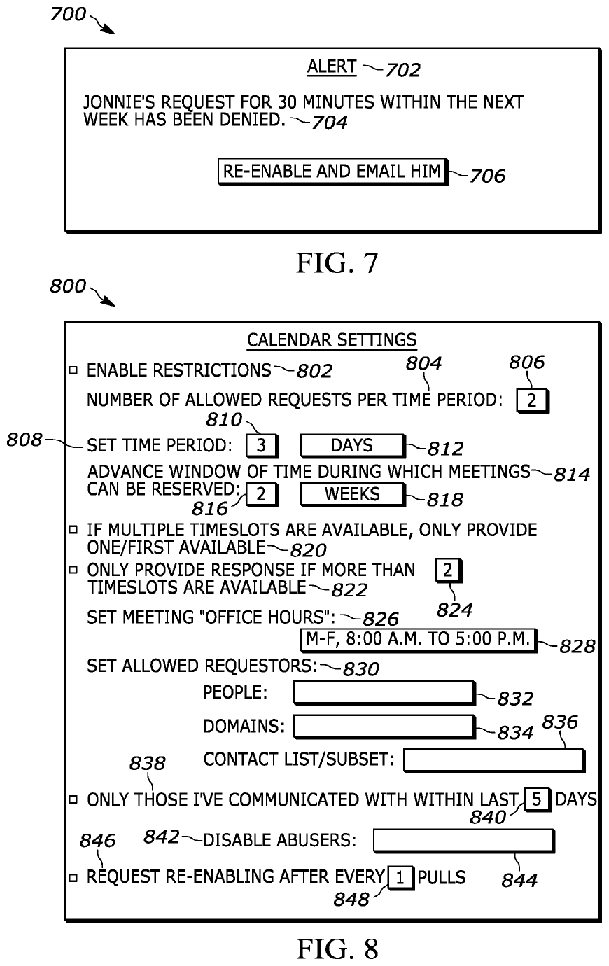

Continuing now in reference to FIG. 7, it shows an example GUI 700 that may also be presented on the display of the second user's device consistent with present principles. But this time, the GUI 700 may be presented if the first user's meeting request was denied rather than approved according to the example discussed above. The GUI 700 might be presented, for example, if the first user requested a meeting according to certain parameters but the second user's electronic calendar could not find a mutually agreeable meeting time based on those parameters and/or based on the second user's calendar restrictions (e.g., like if a threshold number of bookings through a predetermined future time have already occurred and hence the second user's calendar is not permitting any more additional bookings until the predetermined future time).

Thus, the GUI 700 may include a prompt or alert 702 along with text 704 indicating that the first user's request has been denied. The text 704 may also indicate various parameters set forth in the request itself, such as that the request was for a 30-minute block of time within the next week. Though not shown for simplicity, in some examples the text 704 may also indicate a reason the first user's meeting request was denied, such as that the second user's electronic calendar has already booked a threshold number of bookings through a predetermined future time pursuant to a restriction put in place by the second user. However, to override the restriction and allow the first user to book the meeting being sought, a selector 706 may also be presented on the GUI 700 that may be selectable to command the second user's electronic calendar to either allow only the first user's meeting request and to book it accordingly, or to again permit at least the threshold number of bookings through the predetermined future time more generally so that other people in addition to the first user may book more meetings.

Now describing FIG. 8, it shows an example GUI 800 that may be presented on the display of an end-user's device for that end-user to configure, set, or enable one or more restrictions for his or her electronic calendar consistent with present principles. For example, the GUI 800 may be presented on the display of the second user's smart phone per the example above for the second user to set one or more calendar restrictions.

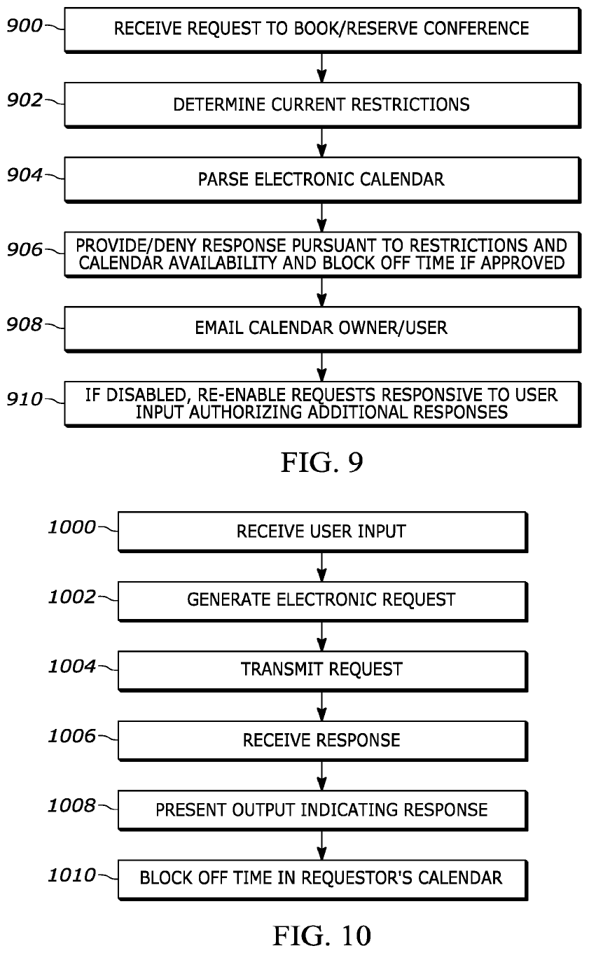

As shown, the GUI 800 may include a first option 802 that may be selectable via the adjacent check box to set or configure the user's electronic calendar to, rather than permit any booking request that is received so long as a requested timeslot is available according to the calendar, permit bookings pursuant to one or more restrictions the user may put in place consistent with present principles. For example, selection of the option 802 may set or enable the device hosting the user's electronic calendar (e.g., Internet server) to execute the logic of FIG. 9, which will be discussed later.

A first such restriction 804 is also shown on the GUI 800, where the restriction may limit a number of booking requests that are permitted/accepted per time period. Numerical input may be entered by the user into input box 806 in order to establish the number of requests, while the time period may be established in the time period section 808 by directing numerical input to input box 810 and then selecting selector 812 to in turn cause a drop-down menu to be presented from which various units of time may be selected (such as days or weeks). The selected unit of time may then be reflected on the face of the selector 814 itself as shown. In this example, the user has limited the number of meeting requests that may be accepted/approved to two requests every three days.

As also shown in FIG. 8, the GUI 800 may indicate a second restriction 814 relating to an advance window of time during which meetings with the user can be reserved via the user's electronic calendar. The window of time may be established by directing numerical input to input box 816 and then selecting selector 818, which in turn may cause a drop-down menu to be presented from which various units of time may be selected (such as days or weeks). The selected unit of time may then be reflected on the face of the selector 818 itself as shown. In this example, the user has limited the window of time to two weeks in advance of the time a given request is received by the electronic calendar.

Note that the second restriction 814 may not be mutually exclusive with the first restriction 804 and thus both restrictions may be enabled and coexist such that a meeting request might have to comply with both restrictions in order to be accepted/booked by the user's electronic calendar. The non-mutually exclusive nature of the first and second restrictions may also apply to the other restrictions discussed herein.

FIG. 8 also shows that the GUI 800 may include a restriction 820 that may be set or enabled via the adjacent check box in order to configure the user's calendar to respond to a meeting request by indicating only one available timeslot, or only a first-available timeslot, that conforms to other restrictions and the meeting request itself (e.g., even if multiple conforming timeslots might be available). So, for example, if the restriction 820 were enabled, then the first user would not be provided with an alternate date and time as shown in section 506 of FIG. 5 as described above and the GUI 500 would only present details for a first-available meeting time.

The GUI 800 may also include a restriction 822 that may be set or enabled via the adjacent check box in order to configure the user's calendar to only provide responses accepting booking requests when more than a threshold number of conforming timeslots are available in the user's electronic calendar. Numerical input may be provided to input box 824 in order to establish the threshold number, which in this case has been established at two. If less than the threshold number of conforming timeslots are available for a given request, then no response may be transmitted back to the requestor at all or message may be transmitted that denies the request.

Additionally, the GUI 800 may include a restriction 826 that may limit the specific days of the week and/or times of day that a meeting may be booked according to a request from another person. In the present example, this is referred to as “office hours” and the office hours may be set by directing text and/or numerical input to input box 828 in order to establish the office hours. In the present example, the office hours have been established as Monday through Friday during the hours of 8:00 a.m. to 5:00 p.m. each of those days such that meeting requests for meeting times outside of those days and/or hours will be automatically declined.

Still in reference to FIG. 8, the GUI 800 may indicate still other restrictions that may be instituted. For example, a restriction may be established so that only certain people predetermined by the user may be allowed to book meetings with user via the electronic calendar. This may be done by the user by directing input to input box 832 to specify particular names, e.g., by actual name, system username, etc.

As another example, a restriction may be established so that only people associated with predetermined Internet domains may be allowed to book meetings with the user via the user's electronic calendar. This may be done by the user by directing input to input box 834 to specify particular domains, whether those are email domains (e.g., “email.com” in the fictional email address “Russell@email.com”) or website domains (e.g., “lenovo.com” in the fictional web addresses “computers.lenovo.com” or “lenovo.com/calendarbookings”). Thus, pursuant to this restriction the calendar may only accept/allow booking requests from people submitting email booking requests using an email address having the predetermined email domain specified by the user via box 834, or submitting website booking requests using a predetermined website domain specified by the user via box 834.

Furthermore, a restriction may be established so that only people or even a subset of people from a user's predetermined contact list may be allowed to book meetings with the user via the electronic calendar. This may be done by the user by directing input to input box 836 to specify or select a particular contact list to use for this restriction, or a subset of people from the contact list to use if, for example, contacts within the list are assigned to different groups such as “friends”, “family” and “colleagues”. In some examples, different restrictions may even be applied to different subsets of people, where restrictions may be configured and saved for one subset and then the user may repeat the process using a GUI like the GUI 800 for another subset or class of people.

Yet another example restriction 838 is shown on the GUI 800, which may be set or enabled by selecting the adjacent check box. The restriction 838 when enabled may permit acceptance of booking requests for only those people with whom the user has electronically communicated in the past within a threshold time of a time at which a given booking request is received, as might be determined using contact information provided by the person/device requesting the meeting itself. The threshold time may be established by directing input to input box 840, and in this case the threshold time has been set to within five days. Whether the person requesting the meeting has communicated electronically with the user/owner of the electronic calendar may be determined by accessing a telephone call history or text message history from the user's smart phone to determine with whom the user has spoken with telephonically in the past or exchanged text messages with in the past. Additionally or alternatively, past electronic communication may be determined by accessing an email account associated with the user to determine with whom the user has emailed within the threshold time. Histories for social media direct messages and postings may also be used, as another example.

As also shown in FIG. 8, a restriction 842 may be put in place to disallow/disable certain people from booking meetings with the user consistent with present principles. These people might be thought of “abusers” by the user in that they might be trying to book an inordinate amount of meetings, keep switching meeting times, etc. The user may specify people by actual name, system username, email address, etc. by typing as much into box 844.

Still another restriction 846 may be included on the GUI 800 as shown in FIG. 8. The restriction 846 may be set or enabled by the user by checking the adjacent check box, and may only allow a threshold total number of booking requests to be accepted by the user's electronic calendar before accepting requests is disabled and the user must then re-enable bookings in order for additional requests to be accepted from anyone (or accepted from the requesting person specifically). This feature may be used instead of disabling certain “abusers” according to the paragraph immediately above, though both restrictions may also be used/applied in combination in some examples. In any case, the threshold number of permitted requests prior to re-enabling—or “pulls” as they might be called—may be set by the user by directing numerical input to box 848. In this case, the threshold number has been set at one.

Referring now to FIG. 9, it shows example logic that may be executed by a device such as the system 100, server 216, or another device at which an electronic calendar is hosted and stored consistent with present principles. Beginning at block 900, the device may electronically receive a request to book or reserve a conference/meeting with a user associated with the calendar. The request may be received through an application that interfaces with the electronic calendar, through an email that includes a plugin linking to the electronic calendar, through a web portal, etc. From block 900 the logic may proceed to block 902.

At block 902 the device may identify current restrictions for the electronic calendar (or plural calendars if the user has more than one e.g. for different purposes). The current restrictions might be those set by the user using the GUI 800 and then stored at the device. From block 904 the device may then parse the user's electronic calendar(s) to identify any potential timeslots that might conform to the parameters specified in the request itself (e.g., 30-minute time block within the next week) as well as that conform to the restrictions themselves. If desired, the device may even access a different electronic calendar associated with the person that submitted the request to verify that a potential timeslot is available in the other person's calendar as well before approving the request. This verification process may be repeated for other people as well if more than two people are to engage in the meeting or conference.

From block 904 the logic may then proceed to block 906 where the device may provide or deny a response to the request pursuant to the restrictions and the user's availability as indicated in the electronic calendar(s) itself. If the meeting or conference is to involve more than the requesting person and the user, the response may also be provided to each additional person as well. If the request is being approved, at block 906 the device may also block off or otherwise reserve the conforming date and time that is approved in the user's electronic calendar(s), in the calendar of the requesting person, and in the calendar(s) of any other people that are to participate in the meeting or conference.

After block 906 the logic may proceed to block 908. At block 908 the device may email or otherwise notify the user/calendar owner that the request has either been accepted or denied. The logic may then proceed to block 910 where, if responses to additional requests for meeting bookings have been disabled based on a threshold number or limit being reached, user input may be received to re-enable and in response the device may re-enable requests.

Continuing the detailed description in reference to FIG. 10, it shows example logic that may be executed by the device of a person requesting a meeting with a user via that user's electronic calendar consistent with present principles. The device executing the logic of FIG. 10 may therefore be a smart phone or laptop computer, for example, and in some examples some or all of the logic may also be executed in conjunction with a server facilitating the request.

The logic of FIG. 10 may begin at block 1000 where the device may receive user input specifying parameters for a meeting that the person would like to book, such as whom the person is seeking a meeting with, how much time the person would like to book, and whether the person is seeking a telephonic or in-person meeting. The person may identify the user by electronic calendar ID, system username, email address, actual name, etc. so that the device may then lookup the corresponding electronic calendar in, e.g., a relational database. So, for example, the user input received at block 1000 may be user input directed to the GUI 300 of FIG. 3 described above.

But also note that in some examples and possibly prior to presenting the GUI 300, the person's device may access and present the user's electronic calendar itself so that the person might be able to view potential available timeslots prior to submitting the request. However, the electronic calendar may restrict the view provided to the person's device in that the user's electronic calendar may indicate available timeslots without also indicating other reserved or already-booked timeslots or associated meeting information for those already-booked timeslots that would result in associated private or personal information being exposed. For example, no event titles, locations, participants, etc. for other already-booked timeslots may be indicated in the view provided to the person's device.

From block 1000 the logic may then proceed to block 1002 where the device may generate the electronic request based on the user input. Then at block 1004 the device may electronically transmit the request to another device hosting the user's electronic calendar along with potentially transmitting identifying information (e.g., a web site address or cloud storage area ID) for the person's own electronic calendar so that the user's calendar can verify commonly-available timeslots before responding to the request. The device executing the logic of FIG. 10 may then await a response from the hosting device, which might be received at block 1006. Then at block 1008 the device executing the logic of FIG. 10 may present an output indicating the response, such as presenting either of the GUIs 400 or 500 described above on a display. Outputs may also be established by audible outputs using a speaker to indicate if the request was accepted or denied, as another example.

From block 1008 the logic may then proceed to block 1010. At block 1010 and assuming the request has been accepted, the device may also block off and/or create a calendar entry for the same time in the person's own electronic calendar. Other details beyond meeting date, time, and duration may also be saved in the entry for the person's own electronic calendar, such as the designated location or telephone number for the meeting, the meeting's participants, etc.

It may now be appreciated that present principles provide for an improved computer-based user interface that improves the functionality and ease of use of the devices and electronic calendars disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. At least one device, comprising:
at least one processor; and
storage accessible to the at least one processor and comprising instructions executable by the at least one processor to:
receive a request to reserve, via an electronic calendar, a conference time; and
responsive to receiving the request, determine a restriction associated with the electronic calendar and electronically respond to the request pursuant to the restriction;
wherein electronically responding to the request comprises presenting, on a display, a graphical user interface (GUI), the GUI presenting a view of the electronic calendar that indicates plural available timeslots in the electronic calendar that conform to the request, the view not indicating already-booked timeslots in the electronic calendar even though at least one timeslot in the electronic calendar has already been booked and is encompassed by a time frame indicated via the view.

2. The at least one device of claim 1, wherein the restriction permits a single request to reserve a conference time via the electronic calendar during a recurring period of time and otherwise rejects requests to reserve conference times during the same recurring period of time.

3. The at least one device of claim 1, wherein the instructions are executable to:
responsive to responding to a threshold number of requests to reserve conference times during a threshold period of time, disable additional responses to requests to reserve conference times via the electronic calendar until a user associated with the electronic calendar again authorizes responses to requests to reserve conference times.

4. The at least one device of claim 1, comprising the display.

5. The at least one device of claim 4, comprising a server that controls the display.

6. A method, comprising:
receiving a request to reserve, via an electronic calendar, a conference time; and
responsive to receiving the request, determining a restriction associated with the electronic calendar and electronically responding to the request pursuant to the restriction;
wherein electronically responding to the request comprises presenting, on a display, a graphical user interface (GUI), the GUI presenting a view of the electronic calendar that indicates plural available timeslots in the electronic calendar that conform to the request, the view not indicating already-booked timeslots in the electronic calendar even though at least one timeslot in the electronic calendar has already been booked and is encompassed by a time frame indicated via the view.

7. The method of claim 6, wherein the restriction permits a single request to reserve a conference time via the electronic calendar during a recurring period of time and otherwise rejects requests to reserve conference times during the same recurring period of time.

8. The method of claim 6, comprising:
responsive to responding to a threshold number of requests to reserve conference times during a threshold period of time, disabling additional responses to requests to reserve conference times via the electronic calendar until a user associated with the electronic calendar again authorizes responses to requests to reserve conference times.

9. At least one computer readable storage medium (CRSM) that is not a transitory signal, the computer readable storage medium comprising instructions executable by at least one processor to:
receive a request to reserve, via an electronic calendar, a conference time; and
responsive to receiving the request, determine a restriction associated with the electronic calendar and electronically respond to the request pursuant to the restriction;
wherein electronically responding to the request comprises presenting, on a display, a graphical user interface (GUI), the GUI presenting a view of the electronic calendar that indicates plural available timeslots in the electronic calendar that conform to the request, the view not indicating already-booked timeslots in the electronic calendar even though at least one timeslot in the electronic calendar has already been booked and is encompassed by a time frame indicated via the view.

10. The CRSM of claim 9, wherein the restriction permits a single request to reserve a conference time via the electronic calendar during a recurring period of time and otherwise rejects requests to reserve conference times during the same recurring period of time.

11. The CRSM of claim 9, wherein the instructions are executable to:
responsive to responding to a threshold number of requests to reserve conference times during a threshold period of time, disable additional responses to requests to reserve conference times via the electronic calendar until a user associated with the electronic calendar again authorizes responses to requests to reserve conference times.
